(19) United States
(12) Patent Application Publication
(10) Pub. No.: US 2024/0033600 A1
(43) Pub. Date: Feb. 1, 2024

(54) Tournament Simulation in Golf

(71) Applicant: STATS LLC, Chicago, IL (US)

(72) Inventors: Kyle Cunningham-Rhoads, Durham, NC (US); Peter McKeever, Düsseldorf (DE)

(73) Assignee: STATS LLC, Chicago, IL (US)

(21) Appl. No.: 18/361,098

(22) Filed: Jul. 28, 2023

Related U.S. Application Data
(60) Provisional application No. 63/369,732, filed on Jul. 28, 2022.

(51) Int. Cl. A63B 69/36; A63B 71/06

(52) U.S. Cl. CPC A63B 69/3691; A63B 69/3605; A63B 71/0669

(57) ABSTRACT

A computing system retrieves historical hole-by-hole data for a plurality of holes for plurality of golf tournaments for a plurality of players. The computing system clusters the plurality of holes into a plurality of clusters of hole types. The computing system generates a strokes gained metric for each hole type of the hole-by-hole data for each player. The computing system adjusts the strokes gained metric for each hole type. The computing system generates a probability of player performance of each player for each hole in the target tournament based at least one the adjusted strokes gained metric. The probability of player performance includes a probability of each player achieving each possible score for each hole. The computing system generates a projected outcome of the tournament by simulating player performance using the probability of player performance of each player.

### CROSS-REFERENCE TO RELATED APPLICATIONS

This application claims priority to U.S. Provisional Application Ser. No. 63/369,732, filed Jul. 28, 2022, which is hereby incorporated by reference in its entirety.

### FIELD OF THE DISCLOSURE

The present disclosure generally relates to a system and method of simulating golf tournaments using an adjusted strokes gained metric.

### BACKGROUND

Ranking players in sports is often a difficult task. For the sport of golf, the difficulty is heightened because there is not a set number of games against a common group of teams within a contained league. Instead, in golf there are tours of varying quality all over the globe. Players that participate in these tournaments are often independent contractors who are either invited to the tournament or qualify via performance in other tournaments.

### SUMMARY

In some embodiments, a method is disclosed herein. A computing system retrieves historical hole-by-hole data for a plurality of holes for plurality of golf tournaments for a plurality of players. The historical hole-by-hole data includes a yardage of each hole and a par associated with each hole. The computing system clusters the plurality of holes into a plurality of clusters of hole types. The computing system generates a strokes gained metric for each hole type of the hole-by-hole data for each player. The computing system adjusts the strokes gained metric for each hole type based on a field of strength metric associated with each tournament, the field of strength metric representing a strength of a player field in a target tournament. The computing system generates a probability of player performance of each player for each hole in the target tournament based at least one the adjusted strokes gained metric. The probability of player performance includes a probability of each player achieving each possible score for each hole. The computing system generates a projected outcome of the tournament by simulating player performance using the probability of player performance of each player.

In some embodiments, a non-transitory computer readable medium is disclosed herein. The non-transitory computer readable medium includes one or more sequences of instructions, which, when executed by a processor, causes a computing system to perform operations. The operations include retrieving, by the computing system, historical hole-by-hole data for a plurality of holes for plurality of golf tournaments for a plurality of players. The historical hole-by-hole data includes a yardage of each hole and a par associated with each hole. The operations further include clustering, by the computing system, the plurality of holes into a plurality of clusters of hole types. The operations further include generating, by the computing system, a strokes gained metric for each hole type of the historical hole-by-hole data for each player. The operations further include adjusting, by the computing system, the strokes gained metric for each hole type based on a field of strength metric associated with each tournament. The field of strength metric representing a strength of a player field in a target tournament. The operations further include generating, by the computing system, a probability of player performance of each player for each hole in the target tournament based at least one the adjusted strokes gained metric. The probability of player performance includes a probability of each player achieving each possible score for each hole. The operations further include generating, by the computing system, a projected outcome of the target tournament by simulating player performance using the probability of player performance of each player.

In some embodiments, a system is disclosed herein. The system includes a processor and a memory. The memory has programming instructions stored thereon, which, when executed by the processor, causes the system to perform operations. The operations include retrieving historical hole-by-hole data for a plurality of holes for plurality of golf tournaments for a plurality of players. The historical hole-by-hole data includes a yardage of each hole and a par associated with each hole. The operations further include clustering the plurality of holes into a plurality of clusters of hole types. The operations further include generating a strokes gained metric for each hole type of the historical hole-by-hole data for each player. The operations further include adjusting the strokes gained metric for each hole type based on a field of strength metric associated with each tournament. The field of strength metric represents a strength of a player field in a target tournament. The operations further include generating a probability of player performance of each player for each hole in the target tournament based at least one the adjusted strokes gained metric. The probability of player performance includes a probability of each player achieving each possible score for each hole. The operations further include generating a projected outcome of the target tournament by simulating player performance using the probability of player performance of each player.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method for generating an adjusted strokes gained metric for each golfer, according to example embodiments.

FIG. 3 is a flow diagram illustrating a method of predicting an outcome for an upcoming tournament, according to example embodiments.

FIG. 4A is a block diagram illustrating an example graphical user interface, according to example embodiments.

FIG. 4B is a block diagram illustrating an example graphical user interface, according to example embodiments.

FIG. 5A is a block diagram illustrating a computing device, according to example embodiments.

FIG. 5B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Due to the nature of golf, it is typically difficult to rank players due to the variety of tours and the variety of fields across tournaments. Tournaments may be played at a wide variety of courses and strength of fields. Due to the variance of individual skill sets of golfers, certain players may be a consistent contender on one course, while struggle on another course. Sometimes this variance may be attributed to the golfer's preference (e.g., the golfer may prefer the first course to the second course). Other times this variance may be attributed to the strength of the field (e.g., the first course may be in a tournament with a weaker field compared to the second course in a second tournament).

Additionally, there is also an issue of small sample size. Golfers typically participate in around twenty sanctioned tournaments a year. Given this small sample size, it is often difficult to accurately train an artificial intelligence model to draw conclusions from, especially considering the variance of individual skill sets. Such limitations also limit the ability of conventional systems to simulate tournament performance.

The present approach improves upon conventional systems by utilizing individual player performance relative to the tournament in which they are playing, as well as calculated recency bias, to generate an adjusted strokes gained metric for each player. Using the adjusted strokes gained metric, the present system may be configured to generate a probability of each player achieving each possible score on each hole of a tournament. The present system may then simulate player performance in the tournament using these probabilities.

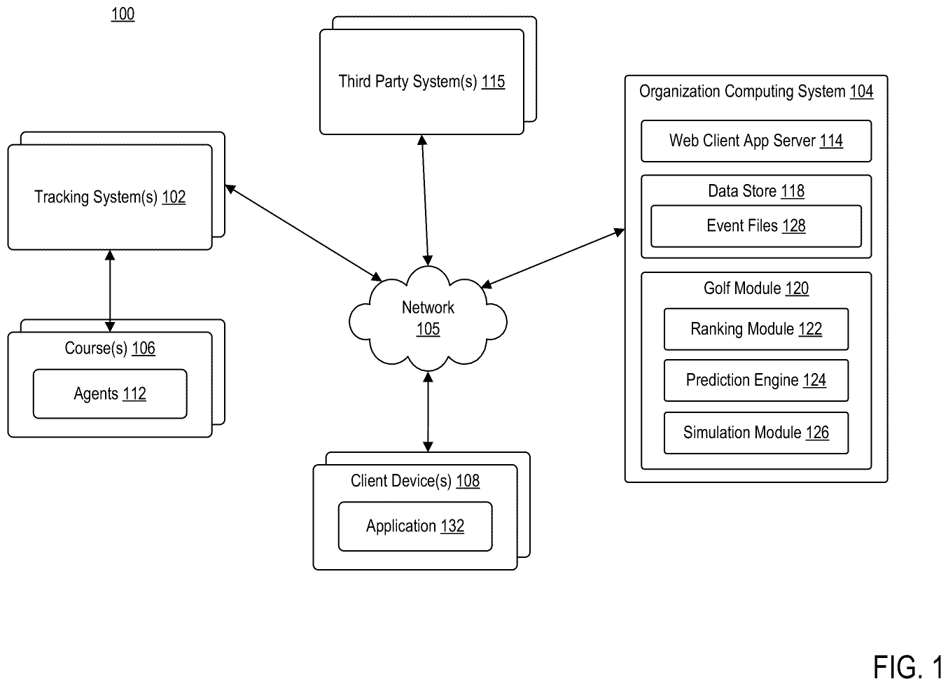

FIG. 1 is a block diagram illustrating a computing environment 100, according to example embodiments. Computing environment 100 may include tracking system 102, organization computing system 104, one or more client devices 108, and one or more third party systems 115 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be associated with a course 106. For example, course 106 may be configured to host a sporting event that includes one or more agents 112 (or golfers). Tracking system 102 may be configured to record the motions of all agents (i.e., players) on the playing surface, as well as one or more other objects of relevance (e.g., ball location, weather predictions, hole number, course name, pin location, hazard locations, stroke count, and the like). In some embodiments, tracking system 102 may be an optically-based system using, for example, a plurality of cameras. In some embodiments, tracking system 102 may be a radio-based system using, for example, radio frequency identification (RFID) tags worn by players or embedded in objects to be tracked. Generally, tracking system 102 may be configured to sample and record, at a high frame rate. Tracking system 102 may be configured to store at least player identity, stroke information, and location (e.g., (x, y) position) for all agents and objects (e.g., ball) on the course for each hole.

Tracking system 102 may be configured to communicate with organization computing system 104 via network 105. Organization computing system 104 may be configured to manage and analyze the data captured by tracking system 102. Organization computing system 104 may include at least a web client application server 114, a data store 118, a golf module 120.

Golf module 120 may be comprised of one or more software modules. The one or more software modules may be collections of code or instructions stored on a media (e.g., memory of organization computing system 104) that represent a series of machine instructions (e.g., program code) that implement one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more event files 128. Each event file 128 may be captured and generated by a tracking system 102. In some embodiments, each of the one or more event files 128 may include all the raw data captured from a tournament or round. For example, the raw data contained in each event file 128 may include, but is not limited to, hole-by-hole information for each golfer. The hole-by-hole information may include the yardage and the stroke number.

Golf module 120 may be configured to generate potential outcomes for an upcoming tournament. As shown, golf module 120 may include ranking module 122, prediction engine 124, and simulation module 126.

Ranking module 122 may be configured to rank golfers globally. To do so, ranking module 122 may analyze the hole-by-hole data of each event file, as well as contextual information (e.g., short-par 3, a long par 4, etc.) about each course and the field of golfers in the tournament, to create an adjusted strokes gained metric for each golfer. By generating a strokes gained metric, as opposed to conventional approaches that use cumulative strokes under par or over par, ranking module 122 is able to take into account the different expectancies of scores across different courses. Relying on cumulative strokes under par or over par can inappropriately weight good performances at courses where scores are very low. For example, a golfer shooting −14 and outscoring the field by three strokes should be weighted similarly to a golfer shooting +2 but outscoring the field by three strokes. By utilizing the strokes gained metric, ranking module 122 can take into account this nuance in golf, thus accounting for different courses having different score expectancies.

Further, one of the benefits of considering hole-by-hole data instead of tournament or round data is that it greatly increases the sample size for prediction engine 124. For example, by considering how each player performs on each hole relative to field average, ranking module 122 effectively increase the sample size for prediction engine 124 eighteen-fold. This allows ranking module 122 to drill down further into both how a player scores on each type of hole and the variance of how they score.

Based on the hole-by-hole data, ranking module 122 may determine how each golfer performs on each hole relative to the field, rather than over a full round or full tournament. In doing so, ranking module 122 may achieve, not only an overall ranking, but a ranking on specific hole types. Such ranking may enable prediction engine 124 to generate more accurate predictions, as prediction engine 124 may be able to decompose a course into specific holes and create a prediction for how any player will perform on each hole.

For each hole the golfer played, ranking module 122 may generate a strokes gained value. This stands in comparison to conventional approaches that analyze a golfer's performance on a per round or per tournament basis. In some embodiments, ranking module 122 may categorize holes based on par, yardage, and hole standard deviation. For example, ranking module 122 may categorize a hole into one of eight types:
Shorter/Easier/Less-Variable Par 3s
Longer/Harder/More-Variable Par 3s
Shorter/Easier/More-Variable Par 4s
Shorter/Harder/Less-Variable Par 4s
Longer/Easier/Less-Variable Par 4s
Longer/Harder/More-Variable Par 4s
Shorter/Easier Par 5s
Longer/Harder Par 5s

As those skilled in the art recognize, the foregoing ranges are exemplary and can be adjusted to the preference of the administrator.

In some embodiments, ranking module 122 may utilize a clustering algorithm to cluster holes into hole types. For example, ranking module 122 may use a k-means clustering algorithm to cluster the historical hole information into k-clusters of hole types.

In some embodiments, for par 3s, historical clusters of a single hole can encompass multiple hole types. A hole may be two-parts shorter/easier/less-variable par 3 and two parts longer/harder/more-variable par 3. This hole would be, for prediction purposes, both types of hole. Similar logic may be applied by ranking module 122 for par 4s. Such categorization may allow ranking module 122 to stylize golfers based on their strengths.

In some embodiments, ranking module 122 may generate a strength of field metric associated with a tournament in which a hole is played. For example, ranking module 122 may generate a strength of field metric using each player in the field's raw historical data (e.g., pure strokes gained or lost in tournaments). In some embodiments, ranking module 122 may generate the strength of field metric at the round-level. For example, a first round of a tournament may have a different strength of field metric compared to the fourth round of the tournament. Such difference in strength of field metrics may be caused by a cut to the field between rounds.

In some embodiments, ranking module 122 may also generate a tour adjustment. Ranking module 122 may generate the tour adjustment by observing strokes gained data for players who have played multiple tours, and comparing their performances. For example, the DP World Tour is 0.79 strokes worse than the PGA Tour; the Asian Tour is 1.60 strokes worse than the PGA Tour.

In some embodiments, one or more third party systems 115 may be associated with servers or websites configured to host strength of field metrics for a tournament. For example, one or more third party systems 115 may be configured to host strength of field metrics associated with the Official World Golf Rankings. The Official World Golf Rankings assigns a strength of field value to each tournament based on who is playing.

It is important to note that the Official World Golf Rankings do not predict future performance of golfers in upcoming tournaments. Instead, the Official World Golf Rankings only assigns world ranking points based on a player's finish in a tournament. In other words, the Official World Golf Rankings may explain how each player has earned their place in upcoming tournaments, but does not predict future performance in the upcoming tournaments.

Using a specific example of the Official World Golf Rankings, Patrick Cantlay plays in tournaments where the average strength of field is 556. Will Zalatoris plays in tournaments where the average strength of field is 232. When looking at their performances in those tournaments, that difference alone is worth about 0.5 strokes. This difference may not seem like a lot, but half a stroke is what separates the No. #17 golfer in the world from the No. #38 golfer.

In some embodiments, ranking module 122 may further adjust the strokes gained metric using one or more recency adjustments. For example, ranking module 122 may utilize a decay formula to weight recency. The recency adjustments help ranking module 122 provide more weight to more recent holes played, compared to holes played 26 tournaments ago.

Using the adjusted strokes gained metrics, ranking module 122 can generate a ranking of golfers based on average course composition of strong tournaments. For example, based on the course composition of strong tournaments, ranking module 122 may determine that there are, on average, 2.54 shorter/easier/less-variable par 3s, 1.55 longer/harder/more-variable par 3s, 1.26 shorter/easier/more-variable par 4s, 3.26 shorter/harder/less-variable par 4s, 4.04 longer/easier/less-variable par 4s, 1.88 longer/harder/more-variable par 4s, 2.10 shorter/easier par 5s, and 1.38 longer/harder par 5s in each course. Ranking module 122 can generate an overall ranking for players based on the average course composition of strong tournaments and the adjusted strokes gained metrics. In some embodiments, the ranking can be weighted based on the one or more recency adjustments. For example, ranking module 122 may apply a decay factor of 0.94. In other words, each tournament may be weighted at 0.94 of the next tournament.

Prediction engine 124 may be configured to project a player's performance in an upcoming tournament on a hole-by-hole basis. Prediction engine 124 may generate a probability of a player scoring a plurality of possible scores on a hole using adjusted strokes gained normalized to field strength for that hole type, player standard deviation on that hole type, projected average hole score based on historical hole information, and projected hole standard deviation using historical hole information. In some embodiments, projected average hole score may be generated using data from each previous time a hole was played. Using this information, prediction engine 124 may compute the cluster using a clustering algorithm to determine the cluster, and then use the collective hole scores and standard deviations as our predictor for how the hole will play in the future. In some embodiments, pin locations may not directly be taken into account. However, tough pin locations may influence the cluster the hole is assigned. If, for example, a hole has easy pin locations for two rounds and hard pin locations for two rounds, the hole may likely fall into multiple cluster types. For prediction purposes, prediction engine 124 may view a hole as multiple types to create some variance in how the hole will play. For example, for each possible stroke from one stroke to fourteen strokes, prediction engine 124 may generate a probability of a player's stroke number on that hole based on the adjusted strokes gained metric of that player for that hole type, player standard deviation, projected hole score, and projected hole standard deviation.

To generate the probabilities of a player achieving a plurality of possible scores on a given hole, prediction engine 124 may utilize a one versus rest logistic regression model. The one versus rest logistic model may generate a model for each possible score type. For example, there may be one regression model for a score of one stroke, a second regression model for a score of two strokes, etc. The probabilities generated by the various models may add up to 100. In this manner, prediction engine 124 may generate a probability of a player achieving each possible score on a given hole.

Simulation module 126 may be configured to simulate player performance in the tournament. For example, given the probabilities of individual player performance for each hole, simulation module 126 may simulate the overall tournament to generate a predicted winner or ranking of golfers in the tournament. In some embodiments, simulation module 126 may utilize Monte Carlo simulations.

In some embodiments, simulation module 126 may be configured to dynamically update the simulation results in real-time, near real-time, or periodically. For example, simulation module 126 may receive an indication of a score in the tournament. In some embodiments, the indication may be representative of the actual results for a given hole for a given player. Based on the actual score, simulation module 126 may re-simulate player performance to generate new tournament predictions. In this manner, simulation module 126 can routinely or periodically provide end users with updated simulated results.

In some embodiments, golf module 120 may be configured to handle a variety of tournament types. For example, for Stableford scoring, rather than a total score, Stableford scoring uses points for scores on each hole. For example, an albatross is worth 5 points, an eagle is worth 4 points, a birdie is worth 3 points, even par is worth 2 points, bogey is worth 1 point, and double bogey or worse is worth 0 points. The process performed by golf module 120 may be substantially the same as the foregoing functionality. However, there is an additional step of assigning points to individual hole scores when ranking and generating future predictions.

In some embodiments, golf module 120 may be configured to handle match play rules (e.g., 1 v. 1 or 2 v. 2). In some embodiments, holes may be scored individually, and only one point can be won on any given hole. If, for example, a golfer beats their opponent by 4 strokes on one hole, it is only counted as a 1-point victory. Holes may be played until one player can no longer win, or through 18 holes in the event of a tie. If a player is down by 3 strokes with 2 holes to play, that player can no longer win the match and the match is scored as a “3 and 2 Victory” for the leading player.

The foregoing techniques can be applied to match play rules. For example, for individual matches, holes may be scored for each player, compared, and then a winner or tie may be determined. This progresses until the match ends in a tie or a player accrues enough points to win. In match play competitions where a bracket-style tournament occurs, golf module 120 may simulate results based on a player's likelihood to win their pool and then win successive single-elimination matches.

Further, it is important to note, that while the foregoing discussion references an individual tournament, where each player or golfer is competing against the rest of the field, those skilled in the art recognize that such techniques can be applied to team play (e.g., Ryder Cup) where, instead of every golfer for themselves, the outcome of the tournament is based on the performance of a team of golfers. In such scenarios, golf module 120 can aggregate the data to generate predictions on a team level.

Further, as those skilled in the art understand, golf module 120 may be utilized to map together performances across tours. For example, golf module 120 may be configured to identify player performance in both the PGA Tour, the LIV Tour, and any other tours. Such mapping may be utilized in joint tournaments, such as the Masters Tournament or the British Open.

Additionally, while the above discussion focuses on men's golf, those skilled in the art understand that such techniques can be applied to women's golf, as well as joint or mixed tournaments that includes golfers from the men's tours and the women's tours.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 132. Application 132 may be representative of a web browser that allows access to a website or a stand-alone application. Client device 108 may use access application 132 to access one or more functionalities of organization computing system 104. Client device 108 may communicate over network 105 to request a webpage, for example, from web client application server 114 of organization computing system 104. For example, client device 108 may be configured to execute application 132 to access content managed by web client application server 114. The content that is displayed to client device 108 may be transmitted from web client application server 114 to client device 108, and subsequently processed by application 132 for display through a graphical user interface (GUI) of client device 108.

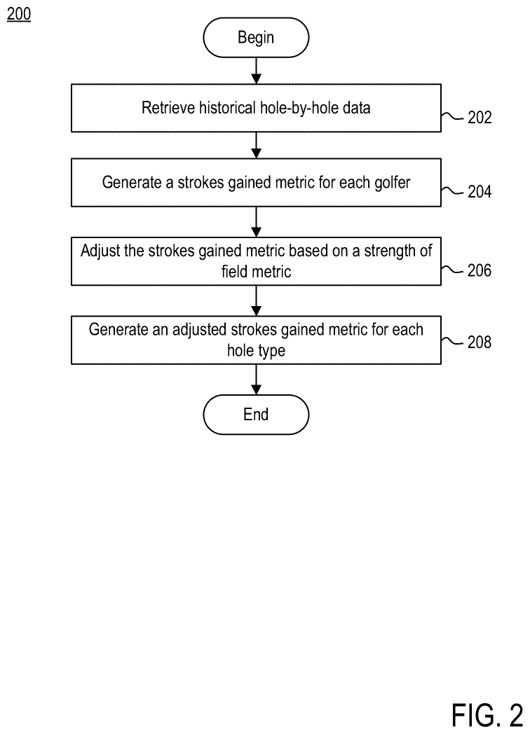

FIG. 2 is a flow diagram illustrating a method 200 for generating an adjusted strokes gained metric for each golfer, according to example embodiments. Method 200 may begin a step 202.

At step 202, organization computing system 104 may retrieve historical hole-by-hole data for a plurality of golfers. The hole-by-hole information may include the yardage and the stroke number associated with each hole, as well as the golfer's score on that hole.

At step 204, organization computing system 104 may generate a strokes gained metric for each golfer based on the hole-by-hole data. Ranking module 122 may analyze the hole-by-hole data of each event file, as well as contextual information about each course and the field of golfers in the tournament, to create the strokes gained metric. Ranking module 122 may generate a strokes gained metric for each hole type. For example, ranking module 122 may generate a strokes gained metric for each of the eight types of holes.

At step 206, ranking module 122 may adjust the strokes gained metric for each golfer based on a strength of field metric associated with a tournament in which a hole is played to generate an adjusted strokes gained metric. For example, ranking module 122 may generate a strength of field metric. In some embodiments, ranking module 122 may generate a strength of field metric using each player in the field's raw historical data (e.g., pure strokes gained or lost in tournaments). In some embodiments, ranking module 122 may generate the strength of field metric at the round-level. For example, a first round of a tournament may have a different strength of field metric compared to the fourth round of the tournament. Such difference in strength of field metrics may be caused by a cut to the field between rounds.

At step 208, organization computing system 104 may generate an adjusted strokes gained metric for each golfer for each hole type. For example, ranking module 122 may aggregate the adjusted strokes gained metric for each hole in the hole-by-hole data to determine the adjusted strokes gained metric for each hole type. The hole types may include, but are not limited to, short par 3s, long par 3s, short par 4s, long par 4s, and par 5s.

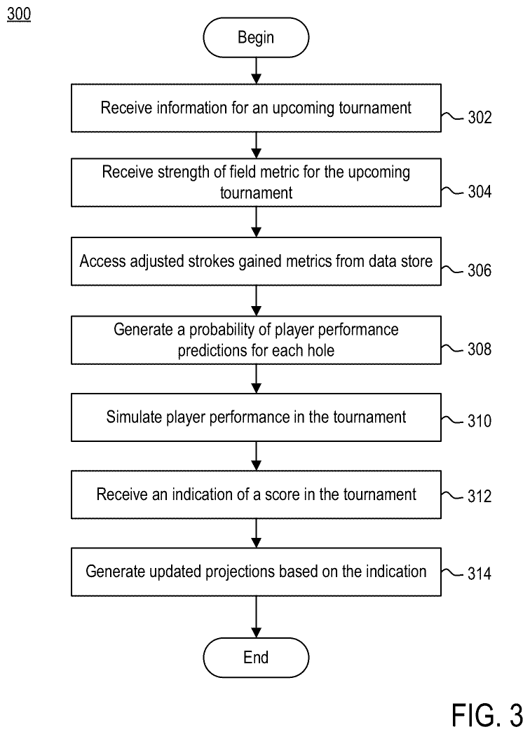

FIG. 3 is a flow diagram illustrating a method 300 of predicting an outcome for an upcoming tournament, according to example embodiments. Method 300 may begin at step 302.

At step 302, organization computing system 104 may receive information for an upcoming tournament. For example, prediction engine 124 may receive hole-by-hole information for each hole in each round of the tournament and the players in the player field. Exemplary hole information may include, but is not limited to, a number of shorter/easier/less variable par 3s, a number of longer/harder/more-variable par 3s, a number of shorter/easier/more-variable par 4s, a number of shorter/harder/less-variable par 4s, a number of longer/easier/less-variable par 4s, a number of longer/harder/more-variable par 4s, a number of shorter/easier par 5s, and a number of longer/harder par 5s.

At step 304, organization computing system 104 may generate a strength of field metric for the upcoming tournament. For example, ranking module 122 may generate a strength of field metric. In some embodiments, ranking module 122 may generate a strength of field metric using each player in the field's raw historical data (e.g., pure strokes gained or lost in tournaments). In some embodiments, ranking module 122 may generate the strength of field metric at the round-level. For example, a first round of a tournament may have a different strength of field metric compared to the fourth round of the tournament. Such difference in strength of field metrics may be caused by a cut to the field between rounds.

At step 306, organization computing system 104 may retrieve adjusted strokes gained metrics from data store 118. For example, prediction engine 124 may retrieve the adjust strokes gained metric, generated by ranking module 122, from data store 118 for each player in the player field for each hole type.

At step 308, organization computing system 104 may generate a probability of player performance predictions for each hole in the upcoming tournament. Prediction engine 124 may generate a probability of a player scoring a plurality of possible scores on a hole using one or more of the adjusted strokes gained metric, player standard deviation, projected average hole score based on historical hole information, and projected hole standard deviation using historical hole information. To generate the probabilities of a player achieving a plurality of possible scores on a given hole, prediction engine 124 may utilize a one versus rest logistic regression model. The one versus rest logistic model may generate a model for each possible score type. For example, there may be one regression model for a score of one stroke, a second regression model for a score of two strokes, etc. The probabilities generated by the various models may add up to 100. In this manner, prediction engine 124 may generate a probability of a player achieving each possible score on a given hole.

At step 310, organization computing system 104 may simulate player performance in the tournament. For example, given the probabilities of individual player performance for each hole, simulation module 126 may simulate the tournament. In some embodiments, simulation module 126 may utilize Monte Carlo simulations.

At step 312, organization computing system 104 may receive an indication of a score in the tournament. For example, organization computing system 104 may receive actual results for a given hole for a given player.

At step 314, organization computing system 104 may generate an updated projections based on the indication. For example, based on the actual score, simulation module 126 may re-simulate player performance to generate new tournament predictions. In this manner, the player performance predictions may update in real-time, near real-time, or periodically (e.g., after every hole), based on real-time tournament data.

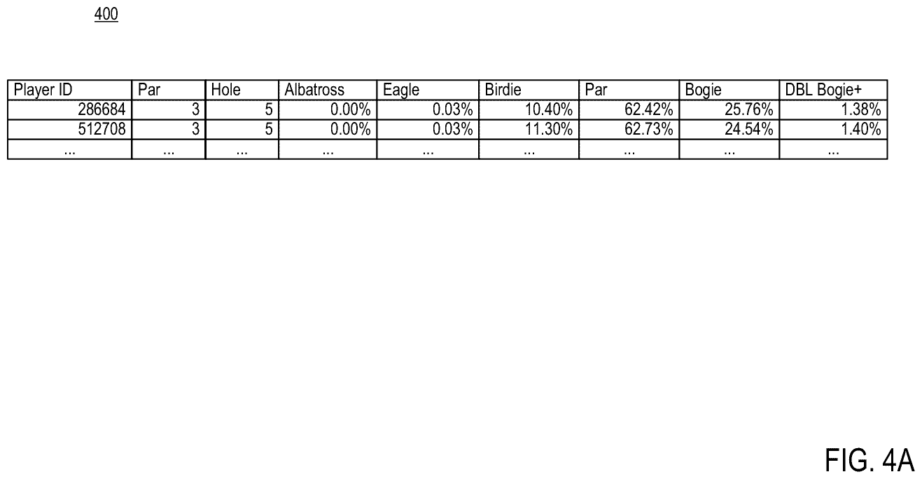

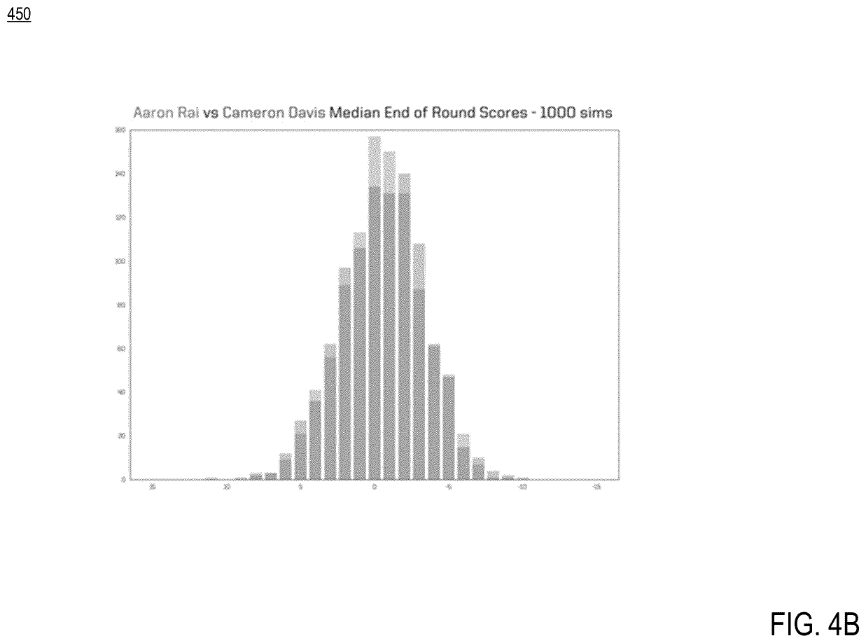

FIG. 4A is a block diagram illustrating an example graphical user interface (GUI) 400, according to example embodiments. GUI 400 may be representative of an exemplary graphical user interface that may be presented to a user via client device 108.

GUI 400 may include predictions generated by golf module 120 for an upcoming tournament. As shown, golf module 120 may generate a percent probability of a player achieving each of a plurality of possible scores on a given hole. For example, for player 286684, on the par 3 hole 5, there is a 0 percent chance of the player achieving an albatross, a 0.03% chance of the player achieving an eagle, a 10.40% chance of the player achieving a birdie, a 62.42% chance of the player achieving a par, a 25.76% chance of the player achieving a bogie, and a 1.38% chance of the player achieving a double bogie.

FIG. 4B is a block diagram illustrating an example graphical user interface (GUI) 450, according to example embodiments. GUI 450 may be representative of an exemplary graphical user interface that may be presented to a user via client device 108. As shown, GUI 450 may compare the median end round scores of two players—Aaron Rai vs. Cameron Davis—after 1000 simulations.

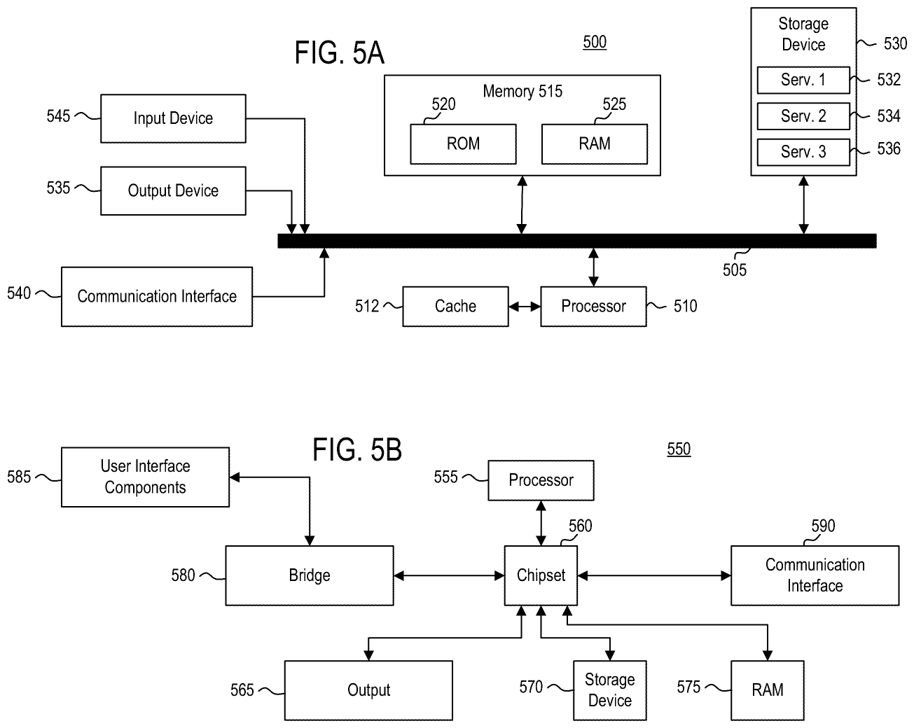

FIG. 5A illustrates an architecture of system bus computing system 500, according to example embodiments. One or more components of system 500 may be in electrical communication with each other using a bus 505. System 500 may include a processor (e.g., one or more CPUs, GPUs or other types of processors) 510 and a system bus 505 that couples various system components including the system memory 515, such as read only memory (ROM) 520 and random access memory (RAM) 525, to processor 510. System 500 can include a cache of high-speed memory connected directly with, in close proximity to, or integrated as part of processor 510. System 500 can copy data from memory 515 and/or storage device 530 to cache 512 for quick access by processor 510. In this way, cache 512 may provide a performance boost that avoids processor 510 delays while waiting for data. These and other modules can control or be configured to control processor 510 to perform various actions. Other system memory 515 may be available for use as well. Memory 515 may include multiple different types of memory with different performance characteristics. Processor 510 may be representative of a single processor or multiple processors. Processor 510 can include one or more of a general purpose processor or a hardware module or software module, such as service 1 532, service 2 534, and service 5 536 stored in storage device 530, configured to control processor 510, as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the system 500, an input device 545 can be any number of input mechanisms, such as a microphone for speech, a touch-sensitive screen for gesture or graphical input, keyboard, mouse, motion input, speech and so forth. An output device 535 (e.g., a display) can also be one or more of a number of output mechanisms known to those of skill in the art. In some instances, multimodal systems can enable a user to provide multiple types of input to communicate with system 500. Communication interface 540 can generally govern and manage the user input and system output. There is no restriction on operating on any particular hardware arrangement and therefore the basic features here may easily be substituted for improved hardware or firmware arrangements as they are developed.

Storage device 530 may be a non-volatile memory and can be a hard disk or other type of computer readable media that can store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 can include services 532, 534, and 536 for controlling the processor 510. Other hardware or software modules are contemplated. Storage device 530 can be connected to system bus 505. In one aspect, a hardware module that performs a particular function can include the software component stored in a computer-readable medium in connection with the necessary hardware components, such as processor 510, bus 505, output device 535 (e.g., a display), and so forth, to carry out the function.

FIG. 5B illustrates a computer system 550 having a chipset architecture, according to example embodiments. Computer system 550 may be an example of computer hardware, software, and firmware that can be used to implement the disclosed technology. System 550 can include one or more processors 555, representative of any number of physically and/or logically distinct resources capable of executing software, firmware, and hardware configured to perform identified computations. One or more processors 555 can communicate with a chipset 560 that can control input to and output from one or more processors 555. In this example, chipset 560 outputs information to output 565, such as a display, and can read and write information to storage device 570, which can include magnetic media, and solid-state media, for example. Chipset 560 can also read data from and write data to storage device 575 (e.g., RAM). A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 555 analyzing data stored in storage device 570 or 575. Further, the machine can receive inputs from a user through user interface components 585 and execute appropriate functions, such as browsing functions by interpreting these inputs using one or more processors 555.

It can be appreciated that example systems 500 and 550 can have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
retrieving, by a computing system, historical hole-by-hole data for a plurality of holes for plurality of golf tournaments for a plurality of players, wherein the historical hole-by-hole data comprises a yardage of each hole and a par associated with each hole;
clustering, by the computing system, the plurality of holes into a plurality of clusters of hole types;
generating, by the computing system, a strokes gained metric for each hole type of the historical hole-by-hole data for each player;
adjusting, by the computing system, the strokes gained metric for each hole type based on a field of strength metric associated with each tournament, the field of strength metric representing a strength of a player field in a target tournament;
generating, by the computing system, a probability of player performance of each player for each hole in the target tournament based at least one the adjusted strokes gained metric, wherein the probability of player performance comprises a probability of each player achieving each possible score for each hole; and
generating, by the computing system, a projected outcome of the target tournament by simulating player performance using the probability of player performance of each player.

2. The method of claim 1, wherein clustering, by the computing system, the plurality of holes into the plurality of clusters of hole types comprises:
assigning each hole of the plurality of holes to the plurality of clusters of hole types, wherein the plurality of clusters of hole types comprises short par threes, long par threes, short par fours, long par fours, and par fives.

3. The method of claim 1, further comprising:
generating the field of strength metric based on each player's raw historical hole-by-hole data on a round-by-round basis.

4. The method of claim 1, wherein the probability of player performance is generated using a one versus rest logistic regression model.

5. The method of claim 4, wherein the one versus rest logistic regression model generates a probability of a first player scoring a plurality of possible scores on each hole.

6. The method of claim 5, further comprising:
generating, using a first regression model, a first probability of the first player achieving a first score of the plurality of possible scores on a first hole; and
generating, using a second regression model, a second probability of the first player achieving a second score of the plurality of possible scores on the first hole.

7. The method of claim 1, further comprising:
receiving, by the computing system, an indication of a score in the target tournament; and
based on the score, updating, by the computing system, the projected outcome of the target tournament.

8. A non-transitory computer readable medium comprising one or more sequences of instructions, which, when executed by a processor, causes a computing system to perform operations, comprising:
retrieving, by the computing system, historical hole-by-hole data for a plurality of holes for plurality of golf tournaments for a plurality of players, wherein the historical hole-by-hole data comprises a yardage of each hole and a par associated with each hole;
clustering, by the computing system, the plurality of holes into a plurality of clusters of hole types;
generating, by the computing system, a strokes gained metric for each hole type of the historical hole-by-hole data for each player;
adjusting, by the computing system, the strokes gained metric for each hole type based on a field of strength metric associated with each tournament, the field of strength metric representing a strength of a player field in a target tournament;
generating, by the computing system, a probability of player performance of each player for each hole in the target tournament based at least one the adjusted strokes gained metric, wherein the probability of player performance comprises a probability of each player achieving each possible score for each hole; and
generating, by the computing system, a projected outcome of the target tournament by simulating player performance using the probability of player performance of each player.

9. The non-transitory computer readable medium of claim 8, wherein clustering, by the computing system, the plurality of holes into the plurality of clusters of hole types comprises:
assigning each hole of the plurality of holes to the plurality of clusters of hole types, wherein the plurality of clusters of hole types comprises short par threes, long par threes, short par fours, long par fours, and par fives.

10. The non-transitory computer readable medium of claim 8, further comprising:
generating the field of strength metric based on each player's raw historical hole-by-hole data on a round-by-round basis.

11. The non-transitory computer readable medium of claim 8, wherein the probability of player performance is generated using a one versus rest logistic regression model.

12. The non-transitory computer readable medium of claim 11, wherein the one versus rest logistic regression model generates a probability of a first player scoring a plurality of possible scores on each hole.

13. The non-transitory computer readable medium of claim 12, further comprising:
generating, using a first regression model, a first probability of the first player achieving a first score of the plurality of possible scores on a first hole; and
generating, using a second regression model, a second probability of the first player achieving a second score of the plurality of possible scores on the first hole.

14. The non-transitory computer readable medium of claim 8, further comprising:
receiving, by the computing system, an indication of a score in the target tournament; and
based on the score, updating, by the computing system, the projected outcome of the target tournament.

15. A system, comprising:
a processor; and
a memory having programming instructions stored thereon, which, when executed by the processor, causes the system to perform operations comprising:
retrieving historical hole-by-hole data for a plurality of holes for plurality of golf tournaments for a plurality of players, wherein the historical hole-by-hole data comprises a yardage of each hole and a par associated with each hole;
clustering the plurality of holes into a plurality of clusters of hole types;
generating a strokes gained metric for each hole type of the historical hole-by-hole data for each player;
adjusting the strokes gained metric for each hole type based on a field of strength metric associated with each tournament, the field of strength metric representing a strength of a player field in a target tournament;
generating a probability of player performance of each player for each hole in the target tournament based at least one the adjusted strokes gained metric, wherein the probability of player performance comprises a probability of each player achieving each possible score for each hole; and
generating a projected outcome of the target tournament by simulating player performance using the probability of player performance of each player.

16. The system of claim 15, wherein clustering the plurality of holes into the plurality of clusters of hole types comprises:
assigning each hole of the plurality of holes to the plurality of clusters of hole types, wherein the plurality of clusters of hole types comprises short par threes, long par threes, short par fours, long par fours, and par fives.

17. The system of claim 15, further comprising:
generating the field of strength metric based on each player's raw historical hole-by-hole data on a round-by-round basis.

18. The system of claim 15, wherein the probability of player performance is generated using a one versus rest logistic regression model that generates a probability of a first player scoring a plurality of possible scores on each hole.

19. The system of claim 18, further comprising:
generating, using a first regression model, a first probability of the first player achieving a first score of the plurality of possible scores on a first hole; and
generating, using a second regression model, a second probability of the first player achieving a second score of the plurality of possible scores on the first hole.

20. The system of claim 15, further comprising:
receiving an indication of a score in the target tournament; and
based on the score, updating the projected outcome of the target tournament.
